(19) United States
(12) Patent Application Publication
(10) Pub. No.: US 2026/0259046 A1
(43) Pub. Date: Sep. 3, 2026

(54) RADAR-BASED DETERMINATION OF TYRE PARAMETERS

(71) Applicant: VOLVO TRUCK CORPORATION, Göteborg (SE)

(72) Inventors: Leo LAINE, Göteborg (SE); Mats RYDSTRÖM, Billdal (SE); Murat KUMRU, Göteborg (SE); Mats JONASSON, Partille (SE); Alireza MARZBANRAD, Göteborg (SE)

(73) Assignee: VOLVO TRUCK CORPORATION, Göteborg (SE)

(21) Appl. No.: 19/549,184

(22) Filed: Feb. 25, 2026

(30) Foreign Application Priority Data
Mar. 3, 2025 (EP) 25161236.2

(51) Int. Cl. G01B 15/04; B60C 23/06; G01M 17/02

(52) U.S. Cl. CPC G01B 15/04; B60C 23/066; G01M 17/02

(57) ABSTRACT

A system and method are described for determining the shape of at least part of a tyre. The system has a plurality of radio-reflective objects associated with the tyre; one or more wheel-mounted radar sensors configured to receive radio waves reflected from each of the plurality of radio-reflective objects; and processing circuitry to: determine a position of each of the plurality of radio-reflective objects based on a corresponding radar measurement made by the one or more wheel-mounted radar sensors; and determine the shape of at least part of the tyre based on the determined positions.

### TECHNICAL FIELD

The disclosure relates generally to vehicle control. In particular aspects, the disclosure relates to radar-based determination of tyre parameters. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

The interaction between the wheel of a vehicle and a ground surface on which the vehicle is travelling are an important factor in the generation of tyre forces of the vehicle, which provide traction for the vehicle when it is in motion. This interaction depends, among other factors, on parameters of the tyres of the vehicle. For example, the shape of the tyre during vehicle motion will affect the contact patch area between the tyre and the ground surface, which will in turn affect the tyre force acting between the tyre and the ground surface. The shape of the tyre may be dependent on parameters such as tyre stiffness and tyre pressure.

Knowledge of these various parameters is important for vehicle motion management, in particular to control tyre forces and achieve various objectives relating to, for example, tyre wear, energy efficiency, traction, stability, and comfort. Accurate and reliable estimation of these parameters therefore enables reliable implementation of a large number of vehicle control functions.

It is therefore desired to provide systems, methods and other approaches for tyre parameter estimation that attempt to resolve or at least mitigate one or more of these issues.

### SUMMARY

This disclosure provides systems, methods and other approaches for determining the shape of at least part of a tyre. One or more wheel-mounted radar sensors are used to determine the positions of a plurality of radio-reflective objects associated with the tyre. For example, the radio-reflective objects may be embedded in the tread of the tyre. Based on the determined positions of the radio-reflective objects, the shape of the part of the tyre comprising the objects can be determined. Further parameters of the tyre, such as a contact patch area between the tyre and a ground surface supporting the tyre, a stiffness of the tyre, a pressure of the tyre, and a tyre force acting between the tyre and a ground surface, can be determined based on the determined shape.

According to a first aspect of the disclosure, there is provided a system for determining the shape of at least part of a tyre, the system comprising: a plurality of radio-reflective objects associated with the tyre; one or more wheel-mounted radar sensors configured to receive radio waves reflected from each of the plurality of radio-reflective objects; and processing circuitry configured to: determine a position of each of the plurality of radio-reflective objects based on a corresponding radar measurement made by the one or more wheel-mounted radar sensors; and determine the shape of at least part of the tyre based on the determined positions.

The first aspect of the disclosure may seek to provide a system capable of reliably and accurately determining the shape of at least part of a tyre. A technical benefit may include that further parameters relevant to tyre and vehicle behaviour, such as contact patch area, tyre stiffness, tyre pressure, and tyre force, can be determined based on proper estimation of tyre shape, thereby improving vehicle safety and control.

Optionally in some examples, including in at least one preferred example, at least some of the plurality of radio-reflective objects are disposed in the body of the tyre, wherein the body of the tyre comprises a radio-permeable material. A technical benefit may include that the system is self-contained in the wheel and capable of acquiring reliable and accurate radar measurements.

Optionally in some examples, including in at least one preferred example, at least some of the plurality of radio-reflective objects are disposed in a radially outermost layer of the body of the tyre. A technical benefit may include that the shape of the tyre at or near a contact point with the ground can be accurately determined, enabling improved determination of parameters such as contact patch area and tyre force.

Optionally in some examples, including in at least one preferred example, at least some of the plurality of radio-reflective objects are disposed on an inner liner of the tyre. A technical benefit may include that that the shape of the tyre at or near an interior space of the tyre can be accurately determined, enabling improved determination of parameters such as tyre pressure.

Optionally in some examples, including in at least one preferred example, at least some of the plurality of radio-reflective objects are arranged in a predetermined pattern from the perspective of the one or more wheel-mounted radar sensors. A technical benefit may include that a known configuration of radio-reflective objects can be used to determine any change in position of the radio-reflective objects over time.

Optionally in some examples, including in at least one preferred example, at least some of the plurality of radio-reflective objects are arranged in one or more radially distributed layers. A technical benefit may include that the shape of the tyre can be determined in a radial direction, enabling improved determination of parameters such as tyre stiffness.

Optionally in some examples, including in at least one preferred example, the processing circuitry is configured to: determine a respective distance between the one or more radar sensors and each of the plurality of radio-reflective objects based on the corresponding radar measurement: and determine the position of each of the plurality of radio-reflective objects based on the respective determined distances. A technical benefit may include that the positions of the radio-reflective objects can be determined in a reliable and accurate manner, and any changes in relative or absolute positions can be determined accordingly.

Optionally in some examples, including in at least one preferred example, the processing circuitry is configured to determine the position of each of the plurality of radio-reflective objects further based on angle data comprised in the corresponding radar measurement. A technical benefit may include that a three-dimensional position of the radio-reflective objects can be determined in a reliable and accurate manner.

Optionally in some examples, including in at least one preferred example, the processing circuitry is further configured to determine one or more of a contact patch area between the tyre and a ground surface supporting the tyre, a stiffness of the tyre, a pressure of the tyre, and a tyre force acting between the tyre and a ground surface based on the determined shape. A technical benefit may include that parameters relevant to tyre and vehicle behaviour can be determined in a reliable and accurate manner, thereby improving vehicle safety and control.

Optionally in some examples, including in at least one preferred example, the processing circuitry is further configured to: determine a first position of each of the plurality of radio-reflective objects based on a first corresponding radar measurement made at a first time by the one or more wheel-mounted radar sensors; determine a second position of each of the plurality of radio-reflective objects based on a second corresponding radar measurement made at a second time by the one or more wheel-mounted radar sensors, wherein the second time is later than the first time; and determine deformation of the tyre between the first time and the second time based on a difference between the first positions and the second positions. A technical benefit may include that tyre shape and deformation over time can be determined and analysed in an accurate manner, thereby improving assessment of tyre behaviour.

Optionally in some examples, including in at least one preferred example, the processing circuitry is configured to determine deformation of the tyre based on one or more of a difference between the absolute first position and the absolute second position of one or more of the plurality of radio-reflective objects and a difference between relative positions of two or more of the plurality of radio-reflective objects. A technical benefit may include that a number of different approaches to assessing tyre deformation are provided. Relative positioning may be more robust as relative positions are almost independent of the position of the the radar sensor.

According to a second aspect of the disclosure, there is provided a tyre comprising the system of the first aspect. The second aspect of the disclosure may seek to provide a tyre capable of reliably and accurately determining at least part of its shape. A technical benefit may include that further parameters relevant to tyre and vehicle behaviour, such as contact patch area, tyre stiffness, tyre pressure, and tyre force, can be determined based on proper estimation of tyre shape, thereby improving vehicle safety and control.

According to a third aspect of the disclosure, there is provided a vehicle comprising the system of the first aspect. The second aspect of the disclosure may seek to provide a vehicle capable of reliably and accurately determining the shape of at least part of a tyre. A technical benefit may include that further parameters relevant to tyre and vehicle behaviour, such as contact patch area, tyre stiffness, tyre pressure, and tyre force, can be determined based on proper estimation of tyre shape, thereby improving vehicle safety and control.

According to a fourth aspect of the disclosure, there is provided a method for determining the shape of at least part of a tyre, the method comprising: receiving, by one or more wheel-mounted radar sensors, radio waves reflected from each of a plurality of radio-reflective objects associated with the tyre; determining, by processing circuitry of a computer system, a position of each of the plurality of radio-reflective objects based on a corresponding radar measurement by the one or more wheel-mounted radar sensors; and determining, by the processing circuitry, the shape of at least part of the tyre based on the determined positions.

The fourth aspect of the disclosure may seek to provide a method capable of reliably and accurately determining the shape of at least part of a tyre. A technical benefit may include that further parameters relevant to tyre and vehicle behaviour, such as contact patch area, tyre stiffness, tyre pressure, and tyre force, can be determined based on proper estimation of tyre shape, thereby improving vehicle safety and control.

According to a fifth aspect of the disclosure, there is provided a computer system for determining the shape of at least part of a tyre, the computer system comprising processing circuitry configured to: receive a radar measurement corresponding to each of a plurality of radio-reflective objects associated with the tyre from one or more wheel-mounted radar sensors; determine a position of each of the plurality of radio-reflective objects based on a corresponding radar measurement by the one or more wheel-mounted radar sensors; and determine the shape of at least part of the tyre based on the determined position.

The fifth aspect of the disclosure may seek to provide a computer system capable of reliably and accurately determining the shape of at least part of a tyre. A technical benefit may include that further parameters relevant to tyre and vehicle behaviour, such as contact patch area, tyre stiffness, tyre pressure, and tyre force, can be determined based on proper estimation of tyre shape, thereby improving vehicle safety and control.

According to a sixth aspect of the disclosure, there is provided a computer-implemented method for determining the shape of at least part of a tyre, the computer-implemented method comprising: receiving, by processing circuitry of a computer system a radar measurement corresponding to each of a plurality of radio-reflective objects associated with the tyre from one or more wheel-mounted radar sensors; determining, by the processing circuitry, a position of each of the plurality of radio-reflective objects based on a corresponding radar measurement by the one or more wheel-mounted radar sensors; and determining, by the processing circuitry, the shape of at least part of the tyre based on the determined position.

The sixth aspect of the disclosure may seek to provide a computer-implemented method capable of reliably and accurately determining the shape of at least part of a tyre. A technical benefit may include that further parameters relevant to tyre and vehicle behaviour, such as contact patch area, tyre stiffness, tyre pressure, and tyre force, can be determined based on proper estimation of tyre shape, thereby improving vehicle safety and control.

According to a seventh aspect of the disclosure, there is provided a computer program product comprising program code for performing, when executed by processing circuitry, the computer-implemented method of the sixth aspect. The seventh aspect of the disclosure may seek to enable new vehicles and/or legacy vehicles to be conveniently configured, by software installation/update, to reliably and accurately determine the shape of at least part of a tyre. A technical benefit may include that further parameters relevant to tyre and vehicle behaviour, such as contact patch area, tyre stiffness, tyre pressure, and tyre force, can be determined based on proper estimation of tyre shape, thereby improving vehicle safety and control.

According to an eighth aspect of the disclosure, there is provided a non-transitory computer-readable storage medium comprising instructions, which when executed by processing circuitry, cause the processing circuitry to perform the computer-implemented method of the sixth aspect. The eighth aspect of the disclosure may seek to enable new vehicles and/or legacy vehicles to be conveniently configured, by software installation/update, to reliably and accurately determine the shape of at least part of a tyre. A technical benefit may include that further parameters relevant to tyre and vehicle behaviour, such as contact patch area, tyre stiffness, tyre pressure, and tyre force, can be determined based on proper estimation of tyre shape, thereby improving vehicle safety and control.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 schematically shows a side view of a vehicle according to an example of the disclosure.

FIG. 2 schematically shows a cross-section of a tyre according to an example of the disclosure.

FIG. 3 schematically shows a system for determining the shape of at least part of a tyre according to an example of the disclosure.

FIG. 4 is a flow chart of a computer-implemented method according to an example of the disclosure.

FIG. 5 is a schematic diagram of a computer system for implementing examples disclosed herein.

Like reference numerals refer to like elements throughout the description.

### DETAILED DESCRIPTION

The detailed description set forth below provides information and examples of the disclosed technology with sufficient detail to enable those skilled in the art to practice the disclosure.

The interaction between the wheel of a vehicle and a ground surface on which the vehicle is travelling are an important factor in the generation of tyre forces of the vehicle, which provide traction for the vehicle when it is in motion. This interaction depends on parameters of the tyres of the vehicle. For example, the shape of the tyre during vehicle motion will affect the contact patch area between the tyre and the ground surface, which will in turn affect the tyre force acting between the tyre and the ground surface. The shape of the tyre may be dependent on parameters such as tyre stiffness and tyre pressure. Knowledge of these various parameters is important for vehicle motion management, in particular to control tyre forces and achieve various objectives relating to, for example, tyre wear, energy efficiency, traction, stability, and comfort. Accurate and reliable estimation of these parameters therefore enables reliable implementation of a large number of vehicle control functions.

To remedy this, systems, methods and other approaches are provided for determining the shape of at least part of a tyre. One or more wheel-mounted radar sensors are used to determine the positions of a plurality of radio-reflective objects associated with the tyre. For example, the radio-reflective objects may be embedded in the tread of the tyre. Based on the determined positions of the radio-reflective objects, the shape of the part of the tyre comprising the objects can be determined. Further parameters of the tyre, such as a contact patch area between the tyre and a ground surface supporting the tyre, a stiffness of the tyre, a pressure of the tyre, and a tyre force acting between the tyre and a ground surface, can be determined based on the determined shape.

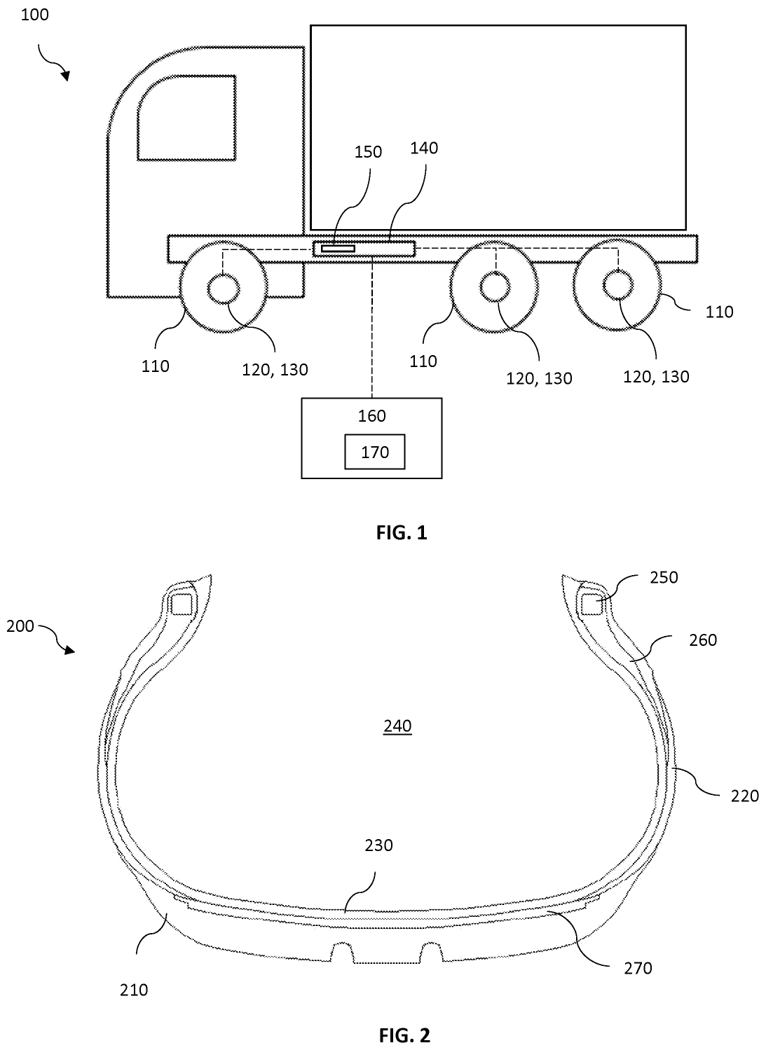

FIG. 1 schematically shows a side view of an example vehicle 100 of the type considered in this disclosure. The vehicle 100 may be any suitable form of vehicle. For example, the disclosure can be applied in heavy-duty vehicles, such as trucks, buses, construction equipment, and multi-unit vehicle combinations, in personal vehicles such as cars, vans, or motorbikes, or in any other suitable form of vehicle. The vehicle 100 comprises a number of axles, each generally having two or more wheels 110. Each wheel is provided with a tyre. Whilst three axles are shown, it will be appreciated that any suitable number of axles may be provided. It will also be appreciated that any number of the axles may be driven axles. The vehicle 100 normally comprises a steered axle, or more than one steered axle.

The vehicle 100 may comprise one or more sources of propulsion. For example, the vehicle 100 may comprise one or more electrical machines 120 such as electric motors and/or generators. The vehicle 100 may comprise one or more batteries (not shown) configured to provide power to the electrical machines 120. In some examples, the vehicle 100 may also include another source of propulsion, for example an internal combustion engine (ICE). The vehicle 100 also comprises a drivetrain (not shown) to deliver mechanical power from the propulsion source (the electrical machines 120 or the ICE) to the wheels 110. The vehicle 100 may be driven solely by ICE, solely by electric machines, or by a combination of electric and combustion engine-based motors.

The electrical machines 120 are configured to drive, e.g. provide torque and/or steering to, one or more axles or individual wheels 110 of the vehicle 100. The electrical machines 120 can supply either a positive (propulsion) or negative (braking) force. The use of electrical machines 120 to supply a negative force is known as regenerative braking, in which case the electrical machines 120 may be operated as generators, in order to recover energy during braking.

Furthermore, the vehicle 100 may comprise one or more sets of service brakes 130. The service brakes 130 can supply a negative (braking) force. The service brakes 130 may be, for example, frictional brakes such as pneumatic brakes. Pneumatic brakes use a compressor to fill the brake with air, which may be powered by the batteries. In some examples, the brakes may be electro-mechanical brakes. The energy recovered from regenerative braking by the electrical machines 120 can be stored in the batteries, and so regenerative braking may generally be preferred overusing service brakes. The electrical machines 120, service brakes 130, and ICE of a vehicle 100 may be referred to as actuators or motion support devices (MSDs) of the vehicle 100.

In some examples, the vehicle 100 may be a vehicle combination comprising a number of units, including a tractor unit and at least one trailing unit. A tractor unit is generally the foremost unit in a vehicle combination, and may comprise the cabin for the driver, including steering controls, dashboard displays and the like. Generally, the tractor unit is used to provide propulsion power for the vehicle combination 100. A trailing unit is generally used to store goods that are being transported by the vehicle combination 100. A trailing unit may be a truck, trailer, dolly and the like. A trailing unit may also provide propulsion to the vehicle combination 100. In such examples, each unit may comprise its own electrical machines 120, batteries, service brakes 130, and the like. In this way, all units may provide propulsion to the vehicle combination 100.

The vehicle 100 may include a controller 140 comprising processing circuitry 150. The controller 140 is configured to control components of the vehicle, for example the electrical machines 120. FIG. 1 shows a common controller 140 for all electrical machines 120 of the vehicle 100, however it will be appreciated that each electrical machine 120 may have its own respective controller 140. In many cases, the controller 140 may be implemented in the structure of the electrical machine 120 itself. The controller 140 may be a microcontroller. In examples where the vehicle 100 is a vehicle combination, the vehicle 100 may include a global controller and a plurality of unit controllers, for example a controller for each unit. Vehicle motion management may therefore be available on a unit level to receive requests from a manual or virtual driver to coordinate the propulsion, braking and steering.

The controller 140 may receive control signals from a computer system 160 comprising processing circuitry 170. The computer system 160 may be a vehicle control unit configured to perform various vehicle (unit) control functions, such as vehicle motion management. The computer system 160 may be local to the vehicle 100, or may be a remote system, implemented at a distance from the vehicle 100. The computer system 160 may be communicatively coupled to the controller 140 in any suitable way, for example via a circuit or any other wired, wireless, or network connection known in the art. Furthermore, the communicative coupling may be implemented as a direct connection between the controller 140 and the computer system 160 or may be implemented as a connection via one or more intermediate entities.

One function of the controller 140 and the computer system 160 is to provide control inputs for the vehicle 100, for example torque, force, or slip requests. To enable these control inputs to be accurate, reliable, and achieve certain objectives, an accurate estimation of tyre parameters is required.

FIG. 2 schematically shows a cross-section of an example tyre 200 of the type considered in this disclosure. Such a tyre may be implemented on one or more of the wheels 110 of the vehicle 100 discussed in relation to FIG. 1. The tyre 200 is built up of several layers, including a tread layer 210 that makes contact with the ground, a sidewall 220, and an inner liner 230 that bounds an interior space 240 of the tyre 200. These components may be made of any suitable material, for example natural or synthetic rubber compounds, or a blend of the two, comprising suitable additives, as known in the art. The tyre 200 also comprises a bead 250 located at the inner edges of the tyre 200 to connect the tyre 200 to the wheel rim, and an apex 260, which is a wedge-shaped rubber component that sits above the bead 250 to provide stability to the sidewall 220 and improve ride comfort. The tyre 200 also comprises a belt or belt reinforcement 270 configured to add structural strength to the tyre 200, improving performance, durability, and safety. The belt 270 is traditionally made of steel, in some examples with additional reinforcement materials, such as Kevlar, nylon, or aramid. In some examples, alternative materials may be used, such as carbon fibre, glass fibre, and other polymer alternatives.

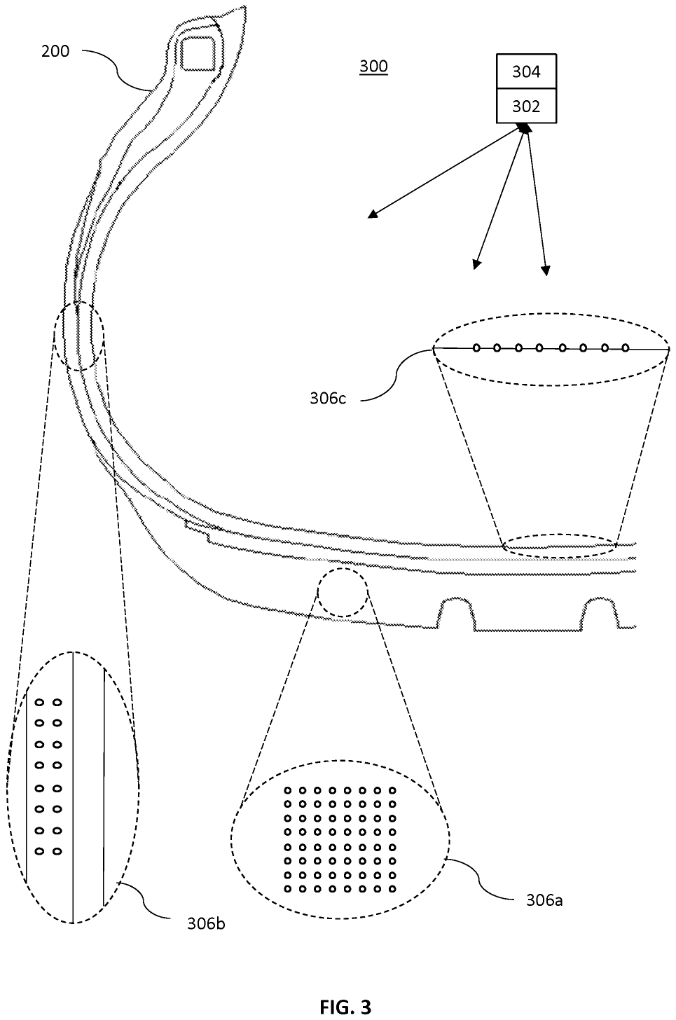

FIG. 3 schematically shows a system 300 for determining the shape of at least part of a tyre 200. Such a system may be implemented in a tyre implemented on one or more of the wheels 110 of the vehicle 100 discussed in relation to FIG. 1. The system 300 comprises at least one wheel-mounted radar sensor 302 and associated processing circuitry 304. The system 300 also comprises a plurality of radio-reflective objects 306 associated with the tyre 200. The radio-reflective objects 306 are discrete, i.e. individually separate and distinct, objects.

The radar sensor 302 comprises a radar antenna and/or transceiver configured to receive and/or transmit radio waves. In particular, the radar sensor 302 emits a radar beam outward towards the radio-reflective objects 306 and receives radar backscatter in the form of reflected radio waves from each of the radio-reflective objects 306. The radar sensor 302 may be configured to emit a radar beam in any suitable direction. By analyzing the time taken for the radio waves to travel to each of the radio-reflective objects 306 and back, the distance between the radar sensor 302 and each of the radio-reflective objects 306 can be determined, as known in the art. Based on a known position of the radar sensor 302, the positions of the radio-reflective objects 306 in the wheel frame of reference can be determined. This can be performed by processing circuitry 304 communicatively coupled to the radar sensor 302.

The radio-reflective objects 306 may be formed in any suitable shape. For example, the radio-reflective objects 306 may be pellets, beads, studs, and the like. The radio-reflective objects 306 may be formed of any suitable radio-reflective material known in the art, such as steel, aluminum, and other metals, conductive polymers, certain dielectric materials, certain composite materials, or other materials with a suitable radio-reflective coating.

The radio-reflective objects 306 may be arranged at any suitable location in the tyre 200 that allows the shape of a corresponding part of the tyre 200 to be determined. For example, the radio-reflective objects 306 may be disposed (e.g. embedded) in the body of the tyre 200. In some examples, radio-reflective objects 306 may be disposed in a radially outermost layer of the body of the tyre 200. For example, radio-reflective objects 306a may be disposed in the tread 210 of the tyre 200, and/or radio-reflective objects 306b may be disposed in the sidewall 220 of the tyre 200. In these examples, the parts of the tyre 200 between the radar sensor 302 and the radio-reflective objects 306a, 306b, e.g. the tread 210, the sidewall 220, the inner liner 230, and the belt 270 are made of a radio-permeable material (i.e. such that radio waves from the radar sensor 302 can be transmitted to and reflected from the radio-reflective objects 306a, 306b). For example, these components of the tyre 200 may comprise materials such as rubber, glass fibre, carbon fibre, suitable polymers, puncture repair gel, road noise absorbing foam, and the like that do not block radio waves from passing through them. In some examples, radio-reflective objects 306c may be disposed on the inner liner 230 of the tyre 200. In these examples, only the inner liner 230 need be radio permeable. In some examples, radio-reflective objects 306c may be disposed on the inner surface of the inner liner 230 of the tyre 200, in which case there is no requirement for the tyre to have radio-permeable components.

The radio-reflective objects 306 may be arranged in any suitable configuration that allows the shape of a corresponding part of the tyre 200 to be determined. For example, the radio-reflective objects 306 may be arranged in a known or predetermined pattern from the perspective of the radar sensor 302 (i.e. into the plane of FIG. 3), for example, a line, grid, circle, and the like. A known configuration can be used as a reference to detect any change in position of the radio-reflective 306 objects over time. The radio-reflective objects 306 may be arranged in one or more radially distributed layers, as shown by the radio-reflective objects 306a, 306b, 306c in FIG. 3. In one example, the radio-reflective objects 306 may be arranged in a grid pattern and in a plurality of radially distributed layers, thereby forming a lattice structure. The radio-reflective objects 306 may be spaced sufficiently distant from each other such that their individual positions can be determined using the radar sensor 302. Such a distance will be readily implementable by the skilled person, for example based on the properties of the signal from the radar sensor 302.

As mentioned above, by analysing the time taken for the radio waves to travel to each of the radio-reflective objects 306 and back, the distance between the radar sensor 302 and each of the radio-reflective objects 306 can be determined, as known in the art. Based on a known position of the radar sensor 302 (for example, at the edge or rim of a hub of the wheel 110, or elsewhere in the wheel 110, such as in a hub cap or other part of the hub, or in part of the tyre 200 itself), the processing circuitry 304 can determine the positions of the radio-reflective objects 306 in the wheel frame of reference. In some examples, the radar sensor 302 may determine the azimuth angle, elevation angle, and slant range for each particular measurement, as known in the art. Based on this, a three-dimensional position of each of the radio-reflective objects 306 can be determined, for example in polar coordinates. In turn, a relative position between each of the radio-reflective objects 306 can also be determined. This may be achieved by matching the determined positions to a known pattern of the radio-reflective objects 306 such that the relative positions between the radio-reflective objects 306 can be determined. Additionally or alternatively, the positions of the radio-reflective objects 306 can be estimated periodically and/or continuously, and the latest measurement can compared to that at a previous timestep.

Once the position of each of the radio-reflective objects 306 is known, a corresponding shape of the part of the tyre 200 comprising the radio-reflective objects 306 can be determined. For example, by mapping the positions of the radio-reflective objects 306 the shape of the tyre 200 can be reconstructed. This can be achieved using any suitable method known to the skilled person. This can be used to determine important information about how the tyre 200 is behaving. For example, the shape of the tyre 200 at a vertically lower portion can be used to determine the contact patch area between the tyre 200 and a ground surface supporting the tyre 200. This can in turn be used to determine tyre force acting between the tyre 200 and the ground surface. The shape of the tyre 200 can also be indicative of a tyre stiffness and/or a tyre pressure. Further detail on this can be found, for example, in “The Dynamic Response of Tyres to Brake Torque Variations and Road Unevennesses” by Peter Willem Anton Zegelaar, Delft University of Technology, March 1998, in particular Chapter 4, “The Rolling Tyre as a Geometric Filter over Short Wavelength Road Unevennesses” and section 4.2, “The flexible ring model”.

This approach can also be used to determine deformation of the tyre 200 over time. For example, the system 300 can be used to determine a first position of each of the radio-reflective objects 306 at a first time, determine a second position of each of the radio-reflective objects 306 at a second time later than the first time, and determine deformation of the tyre 200 between the first time and the second time based on a difference between the first and second positions. By determining the positions of the radio-reflective objects 306 at two or more-time instants, a change in the positions can be determined. This can be achieved based on changes in the absolute positions of the radio-reflective objects 306, or changes in the relative positions between them. Relative positions are almost independent of the position of the the radar sensor 302. As such, an advantage of using relative positions instead of absolute positions is that relative positioning is normally more robust, as the position of the the radar sensor 302 may change due to factors such as mechanical impact and the like. Deformation information can be used to understand tyre dynamics, i.e. how forces are generated with respect to time, which can also be used to analyze tyre stiffness and/or type (e.g. based on how quickly the tyre shape and/or forces change over time).

In some examples, the radar sensor 302 and processing circuitry 304 may be provided in a single, integrated unit. In these examples, the radar sensor 302 may be communicatively coupled to the processing circuitry 304 via any suitable circuit or wired network connection known in the art. In some examples, the radar sensor 302 and processing circuitry 304 may be provided in separate wheel-mounted units. In these examples, the radar sensor 302 may be communicatively coupled to the processing circuitry 304 via any suitable wireless or network connection known in the art. In some examples, the processing circuitry 304 may be implemented by the processing circuitry 150 of the controller 140, or the processing circuitry 170 of the computer system 160 described in relation to FIG. 1. The radar sensor 302 may be communicatively coupled to the controller 140, or the computer system 160 in any suitable way, for example via a circuit or any other wired, wireless, or network connection known in the art. All communicative couplings may be implemented as a direct connection or via one or more intermediate entities.

In the example of FIG. 3, the radar sensor 302 and processing circuitry 304 are mounted in the wheel 110, for example at the edge or rim of a hub of the wheel 110. It may be envisaged that the radar sensor 302 and processing circuitry 304 may be mounted elsewhere in the wheel 110, for example in a hub cap or other part of the hub, or in part of the tyre 200 itself, as long as the radar sensor 302 is capable of receiving reflected radio waves from the radio-reflective objects 306.

Whilst a single radar sensor 302 is shown in FIG. 3, multiple wheel-mounted radar sensors 302 may be present in the system 300. It is noted that a radar sensor 302 generally illuminates an area and not a localized small point, since the radar beam is normally not a true laser-like or pencil-shaped beam. Thus, even single-beam radar sensors simultaneously collect radar backscatter from different observation directions due to the spread of the main radar transmission lobe, i.e., due to the shape of the main lobe of the radar sensor antenna including effects of, e.g., the radar front end on the overall transmission pattern of the radar sensor 302. The radar sensor 302 will therefore be capable of detecting a distance to a number of radio-reflective objects 306 simultaneously. It will be appreciated by the skilled person that more than one radar sensor 302 may be employed to cover a larger area of the tyre 200, in the case that a single radar sensor 302 is not capable of detecting all radio-reflective objects 306 of the tyre 200. In this case, each radar sensor 302 may comprise a radar antenna communicatively coupled to common processing circuitry 304. In another example, each radar sensor 302 may have its own dedicated processing circuitry 304. In some examples, a combination of common and dedicated processing circuitry 304 may be provided. This disclosure is not limited to any particular radar sensor architecture, nor any particular processing circuitry architecture.

The radar beam may also detect backscatter from outside the tyre 200, for example to a ground surface supporting the tyre 200 (including penetrating slightly below the immediate surface of the ground).

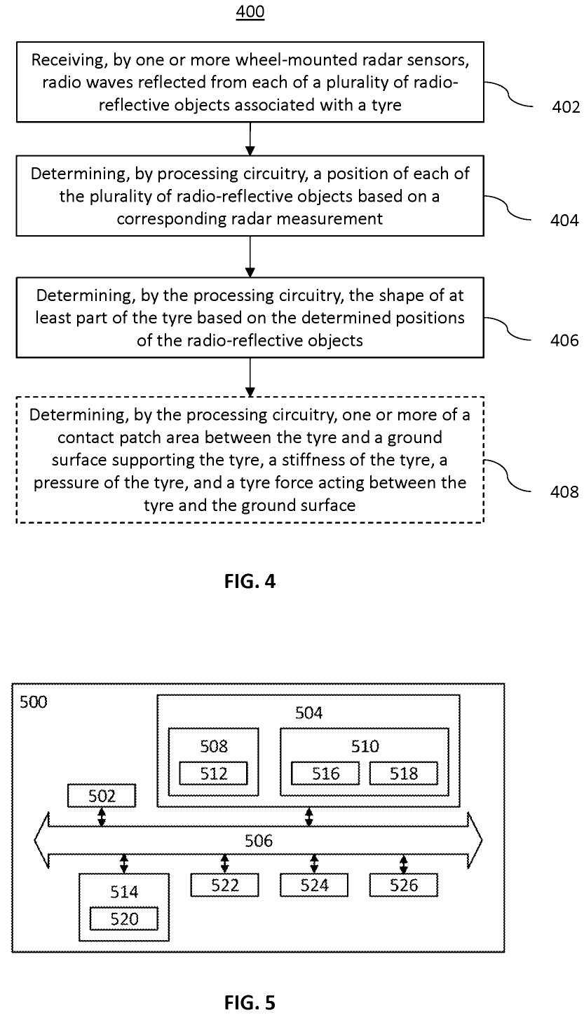

FIG. 4 is a flow chart of a method 400 according to an example. The method 400 is for determining the shape of at least part of a tyre 200. Such a method may be performed in relation to a tyre implemented on one or more of the wheels 110 of the vehicle 100 discussed in relation to FIG. 1. The method 400 enables different tyre parameters to be determine and tyre behavior to be analyzed in a faster, more accurate, manner. The method may be performed by the system 300 discussed in relation to FIG. 3.

At 402, radio waves reflected from each of a plurality of radio-reflective objects 306 associated with the tyre 200 are received by one or more wheel-mounted radar sensors 302. The radio-reflective objects 306 are discrete, i.e. individually separate and distinct, objects. The radar sensor 302 emits a radar beam outward towards the radio-reflective objects 306 and receives radar backscatter in the form of reflected radio waves from each of the radio-reflective objects 306. The radio-reflective objects 306 may be arranged at any suitable location in the tyre 200 and in any suitable configuration that allows the shape of a corresponding part of the tyre 200 to be determined.

The measurements made by the radar sensor 302 are then transmitted to processing circuitry communicatively coupled to the radar sensor 302. In particular, a radar measurement corresponding to each of the radio-reflective objects 306 is transmitted from the radar sensor 302 to the processing circuitry, for example the processing circuitry 304.

At 404, a position of each of the plurality of radio-reflective objects 306 is determined based on a corresponding radar measurement. As discussed above, by analyzing the time taken for the radio waves to travel from the radar sensor 302 to each of the radio-reflective objects 306 and back, the distance between the radar sensor 302 and each of the radio-reflective objects 306 can be determined, as known in the art. Based on a known position of the radar sensor 302 and angle data in the measurement, the position of each of the radio-reflective objects 306 can be determined in the wheel frame of reference, for example in polar coordinates. In turn, a relative position between each of the radio-reflective objects 306 can also be determined. This can be performed by processing circuitry, such as the processing circuitry 304, communicatively coupled to the radar sensor 302.

At 406, the shape of at least part of the tyre 200 is determined based on the determined positions of the radio-reflective objects 306. For example, by mapping the positions of the radio-reflective objects 306 the shape of the tyre 200 can be reconstructed. This can be performed by processing circuitry, such as the processing circuitry 304, communicatively coupled to the radar sensor 302. This can be performed by processing circuitry, such as the processing circuitry 304, communicatively coupled to the radar sensor 302.

At 408, one or more of a contact patch area between the tyre 200 and a ground surface supporting the tyre 200, a stiffness of the tyre 200, a pressure of the tyre 200, and a tyre force acting between the tyre 200 and the ground surface may be determined based on the determined shape. Further detail on this can be found, for example, in “The Dynamic Response of Tyres to Brake Torque Variations and Road Unevennesses” by Peter Willem Anton Zegelaar, Delft University of Technology, March 1998, as discussed above. This can be performed by processing circuitry, such as the processing circuitry 304, communicatively coupled to the radar sensor 302.

In some examples, radar signal reflections from the interior of the tyre can be identified based on detection distance. For example, backscatter received from the inner liner 230 may indicate a different distance to that expected for the radio-reflective objects 306. Such measurements can therefore be discounted from the determination of tyre shape or deformation.

FIG. 5 is a schematic diagram of a computer system 500 for implementing examples disclosed herein. The computer system 500 is adapted to execute instructions from a computer-readable medium to perform these and/or any of the functions or processing described herein. The computer system 500 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 500 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 500 may comprise at least one computing device or electronic device capable of including firmware, hardware, and/or executing software instructions to implement the functionality described herein. The computer system 500 may include processing circuitry 502 (e.g., processing circuitry including one or more processor devices or control units), a memory 504, and a system bus 506. The computer system 500 may include at least one computing device having the processing circuitry 502. The system bus 506 provides an interface for system components including, but not limited to, the memory 504 and the processing circuitry 502. The processing circuitry 502 may include any number of hardware components for conducting data or signal processing or for executing computer code stored in memory 504. The processing circuitry 502 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 502 may further include computer executable code that controls operation of the programmable device.

The system bus 506 may be any of several types of bus structures that may further interconnect to a memory bus (with or without a memory controller), a peripheral bus, and/or a local bus using any of a variety of bus architectures. The memory 504 may be one or more devices for storing data and/or computer code for completing or facilitating methods described herein. The memory 504 may include database components, object code components, script components, or other types of information structure for supporting the various activities herein. Any distributed or local memory device may be utilized with the systems and methods of this description. The memory 504 may be communicably connected to the processing circuitry 502 (e.g., via a circuit or any other wired, wireless, or network connection) and may include computer code for executing one or more processes described herein. The memory 504 may include non-volatile memory 508 (e.g., read-only memory (ROM), erasable programmable read-only memory (EPROM), electrically erasable programmable read-only memory (EEPROM), etc.), and volatile memory 510 (e.g., random-access memory (RAM)), or any other medium which can be used to carry or store desired program code in the form of machine-executable instructions or data structures and which can be accessed by a computer or other machine with processing circuitry 502. A basic input/output system (BIOS) 512 may be stored in the non-volatile memory 508 and can include the basic routines that help to transfer information between elements within the computer system 500.

The computer system 500 may further include or be coupled to a non-transitory computer-readable storage medium such as the storage device 514, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 514 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard coded in circuitry to implement the functionality described herein in whole or in part. The modules may be stored in the storage device 514 and/or in the volatile memory 510, which may include an operating system 516 and/or one or more program modules 518. All or a portion of the examples disclosed herein may be implemented as a computer program 520 stored on a transitory or non-transitory computer-usable or computer-readable storage medium (e.g., single medium or multiple media), such as the storage device 514, which includes complex programming instructions (e.g., complex computer-readable program code) to cause the processing circuitry 502 to carry out actions described herein. Thus, the computer-readable program code of the computer program 520 can comprise software instructions for implementing the functionality of the examples described herein when executed by the processing circuitry 502. In some examples, the storage device 514 may be a computer program product (e.g., readable storage medium) storing the computer program 520 thereon, where at least a portion of a computer program 520 may be loadable (e.g., into a processor) for implementing the functionality of the examples described herein when executed by the processing circuitry 502. The processing circuitry 502 may serve as a controller or control system for the computer system 500 that is to implement the functionality described herein.

The computer system 500 may include an input device interface 522 configured to receive input and selections to be communicated to the computer system 500 when executing instructions, such as from a keyboard, mouse, touch-sensitive surface, etc. Such input devices may be connected to the processing circuitry 502 through the input device interface 522 coupled to the system bus 506 but can be connected through other interfaces, such as a parallel port, an Institute of Electrical and Electronic Engineers (IEEE) 1394 serial port, a Universal Serial Bus (USB) port, an IR interface, and the like. The computer system 500 may include an output device interface 524 configured to forward output, such as to a display, a video display unit (e.g., a liquid crystal display (LCD) or a cathode ray tube (CRT)). The computer system 500 may include a communications interface 526 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

According to certain examples, there is also disclosed:

Example 1: A system (300) for determining the shape of at least part of a tyre (200), the system (300) comprising: a plurality of radio-reflective objects (306) associated with the tyre (200); one or more wheel-mounted radar sensors (302) configured to receive radio waves reflected from each of the plurality of radio-reflective objects (306); and processing circuitry (150, 170, 304) configured to: determine a position of each of the plurality of radio-reflective objects (306) based on a corresponding radar measurement made by the one or more wheel-mounted radar sensors (302); and determine the shape of at least part of the tyre (200) based on the determined positions.

Example 2: The system (300) of example 1, wherein at least some of the plurality of radio-reflective objects (306) are disposed in the body of the tyre (200), wherein the body of the tyre comprises a radio-permeable material.

Example 3: The system (300) of example 2, wherein at least some of the plurality of radio-reflective objects (306) are disposed in a radially outermost layer (210, 220) of the body of the tyre (200).

Example 4: The system (300) of any preceding example, wherein at least some of the plurality of radio-reflective objects (306) are disposed on an inner liner (230) of the tyre (200).

Example 5: The system (300) of any preceding example, wherein at least some of the plurality of radio-reflective objects (306) are arranged in a predetermined pattern from the perspective of the one or more wheel-mounted radar sensors (302).

Example 6: The system (300) of any preceding example, wherein at least some of the plurality of radio-reflective objects (306) are arranged in one or more radially distributed layers.

Example 7: The system (300) of any preceding example, wherein the processing circuitry (150, 170, 304) is configured to: determine a respective distance between the one or more radar sensors (302) and each of the plurality of radio-reflective objects (306) based on the corresponding radar measurement; and determine the position of each of the plurality of radio-reflective objects (306) based on the respective determined distances.

Example 8: The system (300) of example 7, wherein the processing circuitry (150, 170, 304) is configured to determine the position of each of the plurality of radio-reflective objects (306) further based on angle data comprised in the corresponding radar measurement.

Example 9: The system (300) of any preceding example, wherein the processing circuitry (150, 170, 304) is further configured to determine one or more of a contact patch area between the tyre (200) and a ground surface supporting the tyre (200), a stiffness of the tyre (200), a pressure of the tyre (200), and a tyre force acting between the tyre (200) and a ground surface based on the determined shape.

Example 10: The system (300) of any preceding example, wherein the processing circuitry (150, 170, 304) is further configured to: determine a first position of each of the plurality of radio-reflective objects (306) based on a first corresponding radar measurement made at a first time by the one or more wheel-mounted radar sensors (302); determine a second position of each of the plurality of radio-reflective objects (306) based on a second corresponding radar measurement made at a second time by the one or more wheel-mounted radar sensors (302), wherein the second time is later than the first time; and determine deformation of the tyre (200) between the first time and the second time based on a difference between the first position and the second position.

Example 11: The system (300) of any preceding example, wherein the processing circuitry (150, 170, 304) is configured to determine deformation of the tyre (200) based on one or more of a difference between the absolute first position and the absolute second position of one or more of the plurality of radio-reflective objects (306) and a difference between relative positions of two or more of the plurality of radio-reflective objects (306).

Example 12: A tyre (200) comprising the system (300) of any preceding example.

Example 13: A vehicle (100) comprising the system (300) of any preceding example.

Example 14: A method (400) for determining the shape of at least part of a tyre (200), the method (400) comprising: receiving (402), by one or more wheel-mounted radar sensors (302), radio waves reflected from each of a plurality of radio-reflective objects (306) associated with the tyre (200); determining (404), by processing circuitry (150, 170, 304) of a computer system (140, 160), a position of each of the plurality of radio-reflective objects (306) based on a corresponding radar measurement by the one or more wheel-mounted radar sensors (302); and determining (406), by the processing circuitry (150, 170, 304), the shape of at least part of the tyre (200) based on the determined position.

Example 15: The method (400) of example 14, wherein at least some of the plurality of radio-reflective objects (306) are disposed in the body of the tyre (200), wherein the body of the tyre comprises a radio-permeable material.

Example 16: The method (400) of example 14 or 15, wherein at least some of the plurality of radio-reflective objects (306) are disposed in a radially outermost layer (210, 220) of the body of the tyre (200).

Example 17: The method (400) of any of examples 14 to 16, wherein at least some of the plurality of radio-reflective objects (306) are disposed on an inner liner (230) of the tyre (200).

Example 18: The method (400) of any of examples 14 to 17, wherein at least some of the plurality of radio-reflective objects (306) are arranged in a predetermined pattern from the perspective of the one or more wheel-mounted radar sensors (302).

Example 19: The method (400) of any of examples 14 to 18, wherein at least some of the plurality of radio-reflective objects (306) are arranged in one or more radially distributed layers.

Example 20: The method (400) of any of examples 14 to 19, further comprising determining, by the processing circuitry (150, 170, 304), a respective distance between the one or more radar sensors (302) and each of the plurality of radio-reflective objects (306) based on the corresponding radar measurement; and determining, by the processing circuitry (150, 170, 304), the position of each of the plurality of radio-reflective objects (306) based on the respective determined distances.

Example 21: The method (400) of example 20, further comprising determining, by the processing circuitry (150, 170, 304), the position of each of the plurality of radio-reflective objects (306) further based on angle data comprised in the corresponding radar measurement.

Example 22: The method (400) of any of examples 14 to 21, further comprising determining, by the processing circuitry (150, 170, 304), one or more of a contact patch area between the tyre (200) and a ground surface supporting the tyre (200), a stiffness of the tyre (200), a pressure of the tyre (200), and a tyre force acting between the tyre (200) and a ground surface based on the determined shape.

Example 23: The method (400) of any of examples 14 to 22, further comprising determining, by the processing circuitry (150, 170, 304), a first position of each of the plurality of radio-reflective objects (306) based on a first corresponding radar measurement made at a first time by the one or more wheel-mounted radar sensors (302); determining, by the processing circuitry (150, 170, 304), a second position of each of the plurality of radio-reflective objects (306) based on a second corresponding radar measurement made at a second time by the one or more wheel-mounted radar sensors (302), wherein the second time is later than the first time; and determining, by the processing circuitry (150, 170, 304), deformation of the tyre (200) between the first time and the second time based on a difference between the first position and the second position.

Example 24: The method (400) of any of examples 14 to 23, further comprising determining, by the processing circuitry (150, 170, 304), deformation of the tyre (200) based on one or more of a difference between the absolute first position and the absolute second position of one or more of the plurality of radio-reflective objects (306) and a difference between relative positions of two or more of the plurality of radio-reflective objects (306).

Example 25: A computer system (140, 160) for determining the shape of at least part of a tyre (200), the computer system (140, 160) comprising processing circuitry (150, 170, 304) configured to: receive a radar measurement corresponding to each of a plurality of radio-reflective objects (306) associated with the tyre (200) from one or more wheel-mounted radar sensors (302); determine a position of each of the plurality of radio-reflective objects (306) based on a corresponding radar measurement by the one or more wheel-mounted radar sensors (302); and determine the shape of at least part of the tyre (200) based on the determined position.

Example 26: A computer-implemented method for determining the shape of at least part of a tyre (200), the computer-implemented method comprising: receiving, by processing circuitry (150, 170, 304) of a computer system (140, 160), a radar measurement corresponding to each of a plurality of radio-reflective objects (306) associated with the tyre (200) from one or more wheel-mounted radar sensors (302); determining (404), by the processing circuitry (150, 170, 304), a position of each of the plurality of radio-reflective objects (306) based on a corresponding radar measurement by the one or more wheel-mounted radar sensors (302); and determining (406), by the processing circuitry (150, 170, 304), the shape of at least part of the tyre (200) based on the determined position.

Example 27: A computer program product comprising program code for performing, when executed by processing circuitry (150, 170, 304), the computer-implemented method of example 26.

Example 28: A non-transitory computer-readable storage medium comprising instructions, which when executed by processing circuitry (150, 170, 304), cause the processing circuitry to perform the computer-implemented method of example 26.

Terminology used herein is for the purpose of describing particular aspects only and is not intended to be limiting of the disclosure. As used herein, the singular forms "a," "an," and "the" are intended to include the plural forms as well, unless the context clearly indicates otherwise. As used herein, the term "and/or" includes any and all combinations of one or more of the associated listed items. It will be further understood that the terms "comprises," "comprising," "includes," and/or "including" when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as "below" or "above" or "upper" or "lower" or "horizontal" or "vertical" may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being "connected" or "coupled" to another element, it can be directly connected or coupled to the other element, or intervening elements may be present. In contrast, when an element is referred to as being "directly connected" or "directly coupled" to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A system for determining the shape of at least part of a tyre, the system comprising:
a plurality of radio-reflective objects associated with the tyre;
one or more wheel-mounted radar sensors configured to receive radio waves reflected from each of the plurality of radio-reflective objects; and
processing circuitry configured to:
determine a position of each of the plurality of radio-reflective objects based on a corresponding radar measurement made by the one or more wheel-mounted radar sensors; and
determine the shape of at least part of the tyre based on the determined positions.

2. The system of claim 1, wherein at least some of the plurality of radio-reflective objects are disposed in the body of the tyre, wherein the body of the tyre comprises a radio-permeable material.

3. The system of claim 2, wherein at least some of the plurality of radio-reflective objects are disposed in a radially outermost layer of the body of the tyre.

4. The system of claim 1, wherein at least some of the plurality of radio-reflective objects are disposed on an inner liner of the tyre.

5. The system of claim 1, wherein at least some of the plurality of radio-reflective objects are arranged in a predetermined pattern from the perspective of the one or more wheel-mounted radar sensors.

6. The system of claim 1, wherein the processing circuitry is configured to:
determine a respective distance between the one or more radar sensors and each of the plurality of radio-reflective objects based on the corresponding radar measurement; and
determine the position of each of the plurality of radio-reflective objects based on the respective determined distances.

7. The system of claim 6, wherein the processing circuitry is configured to determine the position of each of the plurality of radio-reflective objects further based on angle data comprised in the corresponding radar measurement.

8. The system of claim 1, wherein the processing circuitry is further configured to determine one or more of a contact patch area between the tyre and a ground surface supporting the tyre, a stiffness of the tyre, a pressure of the tyre, and a tyre force acting between the tyre and a ground surface based on the determined shape.

9. A tyre comprising the system of claim 1.

10. A vehicle comprising the system of claim 1.

11. A method for determining the shape of at least part of a tyre, the method comprising:
receiving, by one or more wheel-mounted radar sensors, radio waves reflected from each of a plurality of radio-reflective objects associated with the tyre;
determining, by processing circuitry of a computer system, a position of each of the plurality of radio-reflective objects based on a corresponding radar measurement by the one or more wheel-mounted radar sensors; and
determining, by the processing circuitry, the shape of at least part of the tyre based on the determined position.

12. A computer system for determining the shape of at least part of a tyre, the computer system comprising processing circuitry configured to:
receive a radar measurement corresponding to each of a plurality of radio-reflective objects associated with the tyre from one or more wheel-mounted radar sensors;
determine a position of each of the plurality of radio-reflective objects based on a corresponding radar measurement by the one or more wheel-mounted radar sensors; and
determine the shape of at least part of the tyre based on the determined position.

13. A computer-implemented method for determining the shape of at least part of a tyre, the computer-implemented method comprising:
receiving, by processing circuitry of a computer system, a radar measurement corresponding to each of a plurality of radio-reflective objects associated with the tyre from one or more wheel-mounted radar sensors;
determining, by the processing circuitry, a position of each of the plurality of radio-reflective objects based on a corresponding radar measurement by the one or more wheel-mounted radar sensors; and
determining, by the processing circuitry, the shape of at least part of the tyre based on the determined position.

14. A computer program product comprising program code for performing, when executed by processing circuitry, the computer-implemented method of claim 13.

15. A non-transitory computer-readable storage medium comprising instructions, which when executed by processing circuitry, cause the processing circuitry to perform the computer-implemented method of claim 13.
